(19) United States
(12) Patent Application Publication
(10) Pub. No.: US 2005/0122914 A1
(43) Pub. Date: Jun. 9, 2005

(54) Secure Digital Communication System for High Multi-Path Environments

(75) Inventors: Christopher M. Durso, Carlsbad, CA (US); Alex David Dirdo, Vista, CA (US)

Correspondence Address: CLIFFORD B. PERRY, 449 SANTA FE DR, #312, ENCINITAS, CA, 92024, US

(73) Assignee: PACIFIC MICROWAVE RESEARCH, INC., Vista, CA (US)

(21) Appl. No.: 10/905,158

(22) Filed: Dec. 18, 2004

Related U.S. Application Data
(63) Continuation-in-part of application No. 10/742,068, filed on Dec. 18, 2003.
(60) Provisional application No. 60/485,913, filed on Jul. 8, 2003.
(60) Provisional application No. 60/531,245, filed on Dec. 18, 2003.

(51) Int. Cl. H04Q 11/00

(52) U.S. Cl. 370/270; 380/217

(57) ABSTRACT

A system for communicating secure data within heavily multi-path environments includes a secure transmitter and one or more receivers operable to collect and process received signals transmitted from the secure transmitter.

### CROSS REFERENCE TO RELATED APPLICATIONS

This application is a continuation-in-part application of U.S. application Ser. No. 10/742,068, entitled “Secure Digital Radio Frequency Transmitter,” filed Dec. 18, 2003, which claims priority to U.S. Provisional Application No. 60/485,913, of the same name filed Jul. 8, 2003, the contents of each of which are herein incorporated by reference in its entirety for all purposes. This application further claims the benefit of U.S. Provisional Application No. 60/531,245, entitled “Automatic Adaptive Optimization of Received Data,” filed Dec. 18, 2003, the contents of which are herein incorporated by reference.

### BACKGROUND

The present invention relates generally to systems and methods for communicating data, and more specifically to systems and methods for securely and reliably communicating data in high multi-path environments.

The present invention was borne from the requirement to reliably communicate secure information in a high multi-path environment. A high multi-path environment is one that contains a significant number of buildings, walls, floors, vehicles and other obstructions that could potentially result in numerous reflections of the transmitted signal. Heavily multi-path environments may exist, for example, when attempting to transmit signals within a building, between buildings, to/from a cellular phone or other mobile device within an urban area, or on a battlefield when numerous vehicles or obstructions are in the surrounding area. When the transmitted signal is reflected, it arrives as the receiver out of phase relative to an un-reflected signal. If numerous reflections occur, the reflected wave will increasingly approach a point where it is 180 degrees out of phase with an un-reflected signal, at which point the two signals will destructively interfere, causing the receiver lose the signal. For mobile users, these drop-outs will occur repeatedly as the user moves through the environment. The loss of the transmitted signal, especially when secure data is being communicated, cannot be tolerated in most instances.

Therefore what is needed is an improved system capable of communicating secure data in a heavily multi-path environment without data loss.

### SUMMARY OF THE INVENTION

The present invention provides systems and methods for reliably communicating secure data within heavily multi-path environments. The system includes a secure transmitter, which, in one embodiment includes a data compression module, an encryption module, and a coded orthogonal frequency division multiplex module. The data compression module includes two or more data compression sub-modules, at least one of which is configured to receive and compress video data into a predefined bandwidth and output the compressed video data as a transport sub-stream. The data compression module further includes a multiplexer having a plurality of inputs for receiving the transport sub-streams, and an output for providing a multiplexed output transport stream. The encryption module receives and applies an encryption algorithm to the multiplexed output transport stream, outputting an encrypted transport stream in response. The coded orthogonal frequency division multiplex module receives the encrypted transport stream and is operable to produce an output signal comprising a plurality of sub-carriers, each sub-carrier modulated by data in the encrypted data stream.

The system also includes a receiver operable to collect and process received signals transmitted from the secure transmitter. In a particular embodiment, the receiver includes a low noise amplifier (LNA) assembly, an intermediate frequency (IF) amplifier assembly, a demodulator, and a processor. The LNA assembly includes an input coupled to collect the received signal, an output, and one or more LNA assembly control inputs, the LNA assembly having a variable gain or a variable attenuation responsive to a control signal supplied to the one or more LNA assembly control inputs. The IF amplifier assembly has an input coupled to the output of the low noise amplifier assembly, an output, and one or more IF assembly control inputs, the IF amplifier assembly having a variable gain or a variable attenuation responsive to a control signal supplied to the one or more IF assembly control inputs. The demodulator includes an input for receiving a signal representative of the received signal and is operable to provide a modulation error ratio (MER) signal and a signal strength signal, the MER signal indicating the receiver MER and the signal strength signal indicating the signal level of the received signal. The processor includes an input coupled to receive the MER signal and the signal strength signal, one or more LNA assembly control outputs coupled to respective one or more LNA assembly control inputs, and one or more IF assembly control outputs coupled to respective one or more IF amplifier assembly control inputs. The processor further includes means for determining whether the receiver MER as indicated by the MER signal is above a predefined MER threshold, and whether the received signal level as indicated by the signal level signal is above a predefined signal level threshold. The processor is further operable to (i) increase the attenuation of the LNA assembly, or (ii) increase the attenuation of the IF amplifier assembly, or (ii) decrease the gain of the LNA assembly, or (vi) decrease the gain of the IF amplifier assembly when the receiver MER is determined as being below the predefined MER threshold and the received signal level is determined as being above the predefined signal level threshold.

These and other features of the invention will be better understood when viewed light of the following drawings and detailed description.

### BRIEF DESCRIPTION OF THE DRAWINGS

FIG. 1 illustrates a secure communication system in accordance with one embodiment of the present invention.

FIGS. 2A and 2B illustrate a secure transmitter and method of operation, respectively, in accordance with one embodiment of the present invention.

FIG. 3 illustrates an exemplary embodiment of the data compression module shown in FIG. 2A.

FIG. 4 illustrates an exemplary embodiment of the encryption module shown in FIG. 2A.

FIG. 5 illustrates an exemplary embodiment of the COFDM module shown in FIG. 2A.

FIG. 6 illustrates an exemplary embodiment of the transmit module shown in FIG. 2A.

FIG. 7 illustrates a block diagram of a personnel rapid deployment system in accordance with the present invention.

FIG. 8 illustrates an exemplary embodiment of a data compression module for use with a robotically-transported secure transmitter in accordance with the present invention.

FIG. 9 illustrates a functional block diagram of a robotically-transported communication system in accordance with one embodiment of the present invention.

FIG. 10A illustrates an exemplary circuit block diagram of the receiver shown in FIG. 1 in accordance with one embodiment of the present invention.

FIG. 10B illustrates a method of operation for the receiver shown in FIG. 10A in accordance with the present invention.

For clarity and convenience, features and components in earlier drawings retain their reference numerals in subsequent drawings.

### DETAILED DESCRIPTION

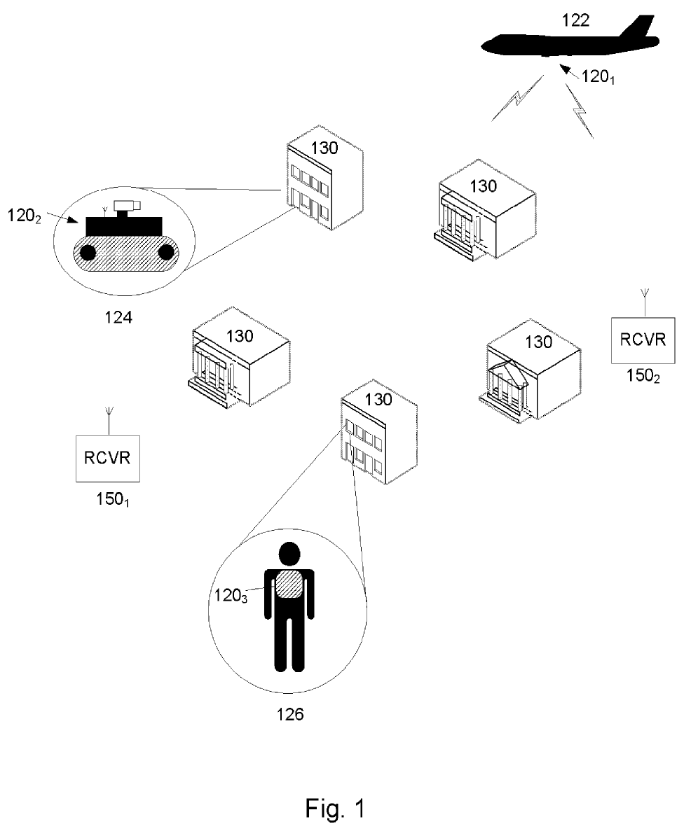

FIG. 1 illustrates a secure communication system for high multi-path environments in accordance with the present invention. The system includes one or more secure transmitters 120 and one or more receivers 150 which are disposed generally in a non-line-of-sight orientation due to buildings, vehicles, or other obstructions 130 which reflect the transmitted signal during the course of signal transmission. As shown, the secure transmitter 120 may be housed in an Unmanned Aerial Vehicle 122 (UAVs) or on a robotically-transported platform (unmanned ground vehicle UGV) 124 to provide remote video surveillance of dangerous areas. Mounted to a tactical UAV, the secure transmitter can provide aerial video imagery of an incident area to support tactical decision making. When mounted to a robotically-transported vehicle, the secure transmitter can provide remote viewing in collapsed buildings, non-line-of-sight environments (e.g., around corners), or other scenarios where it may not be safe to send a First Responder. In a third embodiment, the secure transmitter 120 may be carried in by backpack or similar apparatus by personnel 126 assigned to perform reconnaissance of the particular area.

Transmitter Architecture

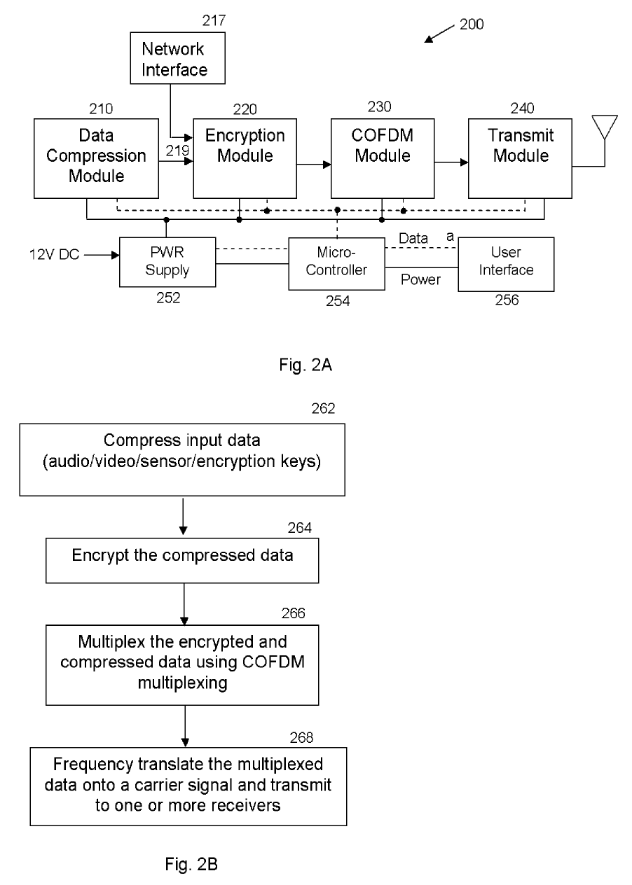

FIGS. 2A and 2B illustrate an exemplary embodiment of a secure transmitter and method of operation, respectively, in accordance with the present invention. Referring to FIG. 2A, the secure transmitter 200 includes a data compression module 210, a network interface 217, an encryption module 220, a coded orthogonal frequency division multiplex (COFDM) module 230, a transmit module 240, a power supply 252, a microcontroller 254, and a user interface 256. Specific embodiments of the data compression module 210, encryption module 220, coded frequency division multiplex module 230, and transmit module 240 are shown and described below. Power supply 252 provides regulated power to each of the modules 210-240, as well as to a microcontroller 254 and user interface 256. Microcontroller 254 is further connected to, and controls the operation of modules 210-240, power supply 252 and user interface 256. User interface 256 provides a means for inputting information, such as selecting or modifying certain parameters of the transmission, and/or means for outputting information e.g., a display screen integrated thereon, or an interface for outputting user interface data 256a. Power supply 252 operates to regulate and provide power from any power source (fixed or portable), exemplary power supplies including line voltage connections, batteries or other low voltage sources, and the like.

Referring now to FIG. 2B, the operation of the secure transmitter will now be described. Initially at 262, an input signal (which may be in analog or digital format) is supplied to the system and compressed. This process can be accomplished by means of the data compression module 210 which operates to reduce the bandwidth of certain supplied signals (e.g., audio and/or video signals) to a fraction of their original bandwidth. The input signal may consist of audio signals, video signals, signals from other sensors (electronic, radiologic, chemical, bio-electronic, etc.) in either analog or digital formats. Video signal may comprise imaged data in the visible spectrum as well as in other regions (e.g., infrared, RF, etc). In a specific embodiment, the video data uses a standard format, such as NTSC, SECAM, PAL, RS-170, or composite signal formats, although any format which can be processed by the system may be used in an alternative embodiment under the present invention.

Alternatively or in addition, input data may also be supplied to the system by means of a network interface 217 which is adapted to convert received network data to a format and protocol required by the encryption module 220. As used herein, the term “network data” refers to data which is typically communicated across a wireline or wireless network, some examples being internet protocol (IP) packets (e.g., TCP/IP, UDP/IP), asynchronous transfer mode (ATM) cell streams, serial byte streams, file(s) in a shared storage medium, Fiber Distributed Data interface (FDDI) data streams, small computer system interface (SCSI) command and data streams. Those skilled in the art will appreciate that the foregoing data formats are only exemplary of those communicated across a network, and that data of any particular format may be used in alternative embodiments under the present invention. Further, the user interface may also be used to provide data for transmission to the receiver. For example, the user interface may be a computer keyboard operable to compose a message for transmission to the receiver.

Encryption data includes one or more keys or codes, an example of which would include a network key and a user-selectable key. The network key insures that receivers outside of the user's network will not be able to decipher transmissions, regardless of the user-selectable key used. The user-selectable key provides the option of intra-network security, in that network receivers not provided with the correct user-selectable key will not decipher the transmission. In a further specific embodiment, this intra-network security feature can be overridden by providing a specific network key. Such a system may be advantageous, for example, in emergency situations where communication between different agencies (e.g., fire, police, Department of Homeland Security) is needed across the same network.

Next at 264, the input data (network data 217, and/or compressed data 219, and/or user interface data 256a) is encrypted. In the illustrated embodiment, encryption is performed through the application of an encryption algorithm using the input encryption data, which, in one embodiment would comprise the combination of the network and user-selectable keys. Further specifically, the encryption algorithm used is based upon the Advanced Encryption Standard (AES), a U.S. Federal Information Processing Standard adopted by the National Institute of Standards and Technology (NIST) to protect sensitive government information. Other encryption protocols such as the Triple Data Encryption Standard (3DES) may be used as well. Those skilled in the art will appreciate that the invention is not limited to a particular encryption standard, and other encryption standards may be used equally as well in alternative embodiments under the present invention.

Subsequently at 266, the compressed and encrypted signal is multiplexed using coded orthogonal frequency division multiplexing. Specifically, the compressed and encrypted signal is modulated onto a plurality of substantially orthogonal sub-carriers, and those modulated sub-carriers combined to form a composite signal. Next at 268, the composite signal is frequency translated (e.g., up-converted) onto a desired carrier signal for transmission to one or more receivers. The systems operable to carry out these functions are further illustrated and described below.

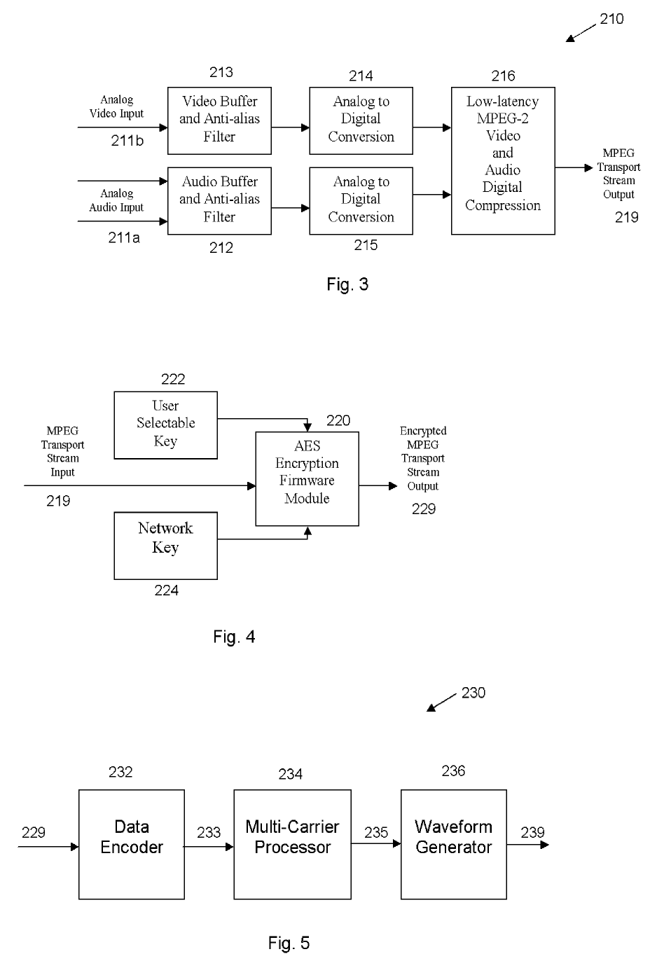

FIG. 3 illustrates an exemplary embodiment of the data compression module 210 shown in FIG. 2A. The data compression module 210 includes buffers and anti-aliasing filtering 212 and 213 operable to condition the supplied audio and video signals 211a and 211b. In a particular embodiment, the audio signal 211a includes two audio channels, the bandwidth of each generally in the range of 10 Hz-20 kHz. The supplied video signal 211b comprises a bandwidth conventional with its format, i.e., 6 MHz for a NTSC signal, 8 MHz for PAL, etc. The conditioned audio and video signals are then converted into digital signals via respective analog-to-digital converters 214 and 215. While the audio and video signals 211a and 211b are described as analog signals, one or both may be supplied in digital form, in which case the buffers and anti-aliasing filters 212/213, and analog-to-digital converters 214/215 may be omitted.

The digitally formatted video and audio signals are input to a data compression circuit 216, which produces, in response, a transport stream 219 containing the compressed audio and video information. In a particular embodiment, the data compression circuit 216 employs the MPEG-2 compression standard using a low latency implementation. To achieve similar low latency affects, the MPEG-2 coding algorithm may be limited to intra (I) and predicted (P) pictures, and bi-directional pictures and/or interpolation may be omitted. In this embodiment, the collective bandwidth of the transport stream audio and video data is compressed to less than 5 Mb/s. Of course, these and other features available in the MPEG suite may be employed in other embodiments of the present invention. Further, while the supplied signals comprise audio and video information, other types of information may be provided alternatively or in addition to these. The term “transport stream” is used as a general term to refer to the data output from each of modules 210, 217, and 220 and does not indicate any particular signal or data format.

FIG. 4 illustrates an exemplary embodiment of the encryption module 220 shown in FIG. 2A. The encryption module 220 comprises an AES module which receives the compressed data comprising the transport stream 219, a user-selectable key 222, and a network key 224. In the particular embodiment illustrated, the AES module 220 comprises firmware which uses the Advanced Encryption Standard to encrypt the input data (network data 217 and/or compressed data 219, and/or user interface data 256a) using user-selectable key 222 and the network key 224, to produce an encrypted transport stream. As noted previously, the invention is not limited to the use of a particular encryption standard, and any standard may be employed in alternative embodiments. Further, one or both of the network or user-selectable keys may be omitted in the encryption process in alternative embodiments.

FIG. 5 illustrates an exemplary embodiment of the COFDM module 230 shown in FIG. 2A. The COFDM module 230 includes a data encoder 232, a multi-carrier processor 234, and a waveform generator 236.

The data encoder 232 receives the encrypted transport stream 229, and applies a forward error correction (FEC) algorithm thereto to produce an encoded transport stream 233. Any FEC coding may be employed, some examples being Convolution coding, Reed-Solomon coding, Bose-Chaudhuri-Hocquenghem (BCH) coding, Turbo coding, and the like. In a particular embodiment, the data encoder 232 further includes a data interleaver operable to generate an interleaved symbol stream, whereby symbols received from the FEC encoder are arranged in the stream in an interleaved fashion, thereby providing greater immunity to noise and drop-outs. In a further specific embodiment, a cyclic prefix module is implemented to insert a predefined cyclic prefix into each symbol of the interleaved symbol stream, thereby decreasing the effects of intersymbol interference that may occur when receiving reflected signals of large amplitudes. In such embodiments, the cyclic prefix module operates to prepend to each symbol, a 1/32, 1/16, ⅛, or ¼ portion of that symbol's length, the prepended length operating as a guard interval to combat the aforementioned effects. The resulting encoded symbol stream 233 is subsequently output from the COFDM module 230.

In a particular embodiment, the encoded transport stream 233 is converted to a plurality of parallel streams, each supplying FEC-encoded data to the multi-carrier processor 234. The multi-carrier processor 234 generates a plurality of substantially orthogonal sub-carriers and modulates each by the supplied FEC-encoded data to produce a respective plurality of modulated sub-carriers. The plurality of modulated sub-carriers are subsequently combined/serialized (within the multi-carrier processor 234 or external thereto) to form a composite signal 235, the composite signal 235 representing the collective spectrum of modulated sub-carriers. In a particular embodiment, the composite signal 235 is realized as two parallel data streams, an I data stream consisting of I (in-phase) terms, and a Q data stream consisting of Q (quadrature phase) terms.

In a particular embodiment, the multi-carrier processor 234 comprises firmware which executes an Inverse Discrete Fourier Transform (IDFT), and in a more specific embodiment, an Inverse Fast Fourier Transform (IFFT) to generate the substantially orthogonal sub-carriers. The number of sub-carriers generated can vary depending upon the noise immunity and modulation error ratio (MER) desired, and may be a number comprising power of 2 for faster FFT computational speed, and is typically greater than 200. For example, the number of sub-carriers may range from 250 to 10,000, and in exemplary embodiments comprise 1,705 sub-carriers (as known in a 2 k or 2048 FFT size sub-carrier system) or 6,817 sub-carriers (as known in an 8 k or 8192 FFT size sub-carrier system).

Furthermore, any type of modulation may be used in modulating segments of the encoded transport stream 233 onto the sub-carriers. Exemplary modulation formats include phase shift keying and amplitude modulation, specific examples of which include bipolar and quadrature phase shift keying, and 16 point (QAM-16) and 64 point (QAM-64) quadrature amplitude modulation formats, respectively. These modulation techniques are only exemplary, and those skilled in the art will readily appreciate that any modulation format may be used in alternative embodiments under the present invention.

Next, the composite signal 235 (in the form of I and Q data streams in one embodiment) and a first carrier signal f_{c1}, are supplied to the waveform generator 236. Therein, the I and Q data streams are modulated onto the first carrier signal f_{c1}, producing the output signal 239.

Depending upon the signal characteristics of the output signal 239 (e.g., frequency, power, etc.), it may be communicated to one or more receivers without further signal conditioning in accordance with the present invention. In such an instance, the frequency of the output signal 239 may be selected to be any frequency appropriate for the application, the selection being dependent upon various factors, including desired transmission bandwidth and range, power consumption, regulatory allocations, and environmental factors. In a particular embodiment, the frequency of the output signal ranges from 50 MHz to 50 GHz, including operation within the P, L, S and C bands, and in more particular embodiments, within the 1 GHz to 6 GHz frequency range. Further, the transmission bandwidth may also be made variable, ranging from 100 KHz to 100 MHz, and more in more particular embodiments, from 1 MHz to 10 MHz.

In another embodiment, the output signal 239 is further conditioned by means of the transmit module 240 to provide signal power level, transmission frequency, and/or other signal characteristics that are desired prior to transmission.

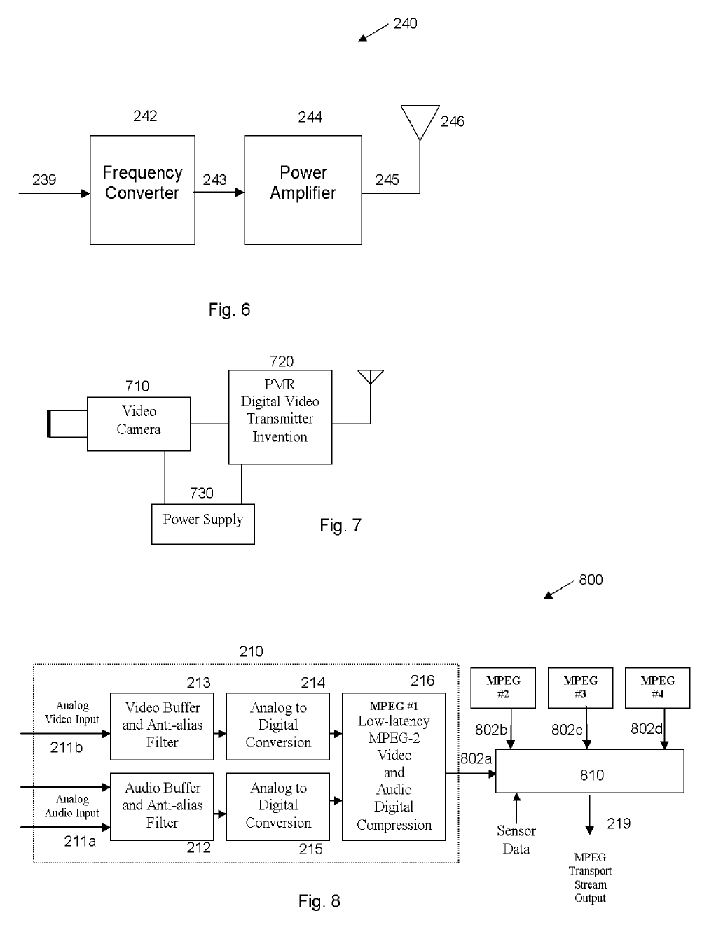

FIG. 6 illustrates an exemplary embodiment of the transmit module 240 shown in FIG. 2A. The transmit module 240 includes a frequency converter 242, power amplifier 244, and antenna 246. The frequency converter 242 receives a carrier signal (not shown) and converts the output signal 239 (up or down in frequency) to a second output signal 243. The second output signal 243 is supplied to the power amplifier 244, after which the amplified signal 245 is transmitted from the antenna 246 to one or more receivers.

As noted above with regard to the frequency of the output signal 239, the frequency of the second output signal 243 may be any frequency appropriate for the application and conditions. In a particular embodiment, the frequency of the second output signal 243 ranges from 50 MHz to 50 GHz, including P, L, S and C bands, and in more particular embodiments, from 1 GHz to 6 GHz. Further, the transmission bandwidth may also be made variable, ranging from 100 KHz to 100 MHz, and in more specific embodiments from 1 MHz to 10 MHz. The particular power amplifier and antenna selected will in turn depend upon the carrier frequency chosen, and the aforementioned factors. In a typical embodiment, the power amplifier 244 will be selected to provide 1 mW to 10 W output power, and in more particular embodiments from 50 mW to 1 W output power at the carrier frequency. The antenna 246 selected may be of a directional or omni-directional type, and is most preferably of a form having the smallest cross-sectional area and weight associated therewith.

The secure transmitter has particular applicability in the areas of Homeland Security, law enforcement, military, intelligence, as well as in commerce when the reliable transmission of secure information is required. The secure transmitter provides a way by which users can securely transport information, e.g., audio and/or video information, for investigative, forensic, intelligence and First Responder applications in Homeland Security. The secure transmitter can provide point-to-point or point-to-multipoint transmission capability due to the digital transmission implementation, and can be placed in the environment on a temporary basis to provide the user with remote video surveillance in a non-line-of-sight environment. Due to its low power consumption, the secure transmitter can be powered from a battery and used in fixed, mobile, or portable applications. Moreover, it can be housed in a rugged environmental housing milled from 6061-T6 Aluminum to withstand the harsh environments typically found at emergency incidents. These features make the secure transmitter ideal for application in Crisis Management and Law Enforcement Coordination activities.

FIG. 7 illustrates a block diagram of a personnel rapid deployment system in which a camera 710 and secure transmitter 720 are powered from a low voltage power supply 730, such as a 12V DC battery. The camera 710 may be a hand held, helmet mounted, or the like, and provide video information over one or more spectrums (visible, shortwave infrared, longwave infrared, etc.) A microphone or other sensor may be connected to the secure transmitter to collect additional information. The secure transmitter 720 may be belt-mounted or carried by backpack (as shown in FIG. 1, 120₃) and the transmitter's antenna 740 may be helmet-mounted or extendable out of a backpack to provide maximum transmission range. User controls, such as channel selection, transmitted power level, audio gain, and user encryption key settings may be selected by means of a LCD screen located on, or connected to the secure transmitter. The LCD screen or other output device may also provide information to the user as well. The rapid deployment system allows the user to move through the environment while providing video imagery and audio to a command post for analysis.

Robotically Transported Multi-Channel Transmission System

In one embodiment, the secure transmitter is deployed as robotically transported multi-channel digital video/audio/data transmission system (124, as shown in FIG. 1). A robotic system is particularly useful in providing law enforcement, military, intelligence, and commercial users a means to securely communicate information safely from a hazardous environment, for instance in investigative, forensic, intelligence and First Responder applications in Homeland Security. The system can provide point-to-point or point-to-multipoint transmission capability, and can be placed in the environment on a temporary basis to provide the user with remote video surveillance in a non-line-of-sight environment.

In a particular embodiment, the robotically-transported secure transmitter includes the features and components as described herein, with the data compression module 210 further including additional systems and means for multiplexing and compressing multiple data streams onto the compressed data stream 219. For example, the robotically-transported secure transmitter may include multiple cameras to provide several different viewing angles. Alternatively or in addition, the additionally multiplexed data streams may originate from audio sensors, or other modality of sensors, such as biologic, chemical, or radiologic sensors. Those skilled in the art will appreciate that other sensors may be used in combination with the present invention; all that is necessary is that the monitored data be convertible to a form which can be multiplexed on a digital data stream.

FIG. 8 illustrates an exemplary embodiment of a data compression module 800 for use with a robotically-transported secure transmitter in accordance with the present invention, with previously identified features retaining their reference indicia. As shown, the data compression module 800 includes four data compression sub-modules 802a-d, each coupled to the input of a multiplexer 810, each being as that described in FIG. 3. In the exemplary embodiment shown, four separate sub-modules are employed, each operable to receive and compress audio/video sensor data according to the MPEG-2 standard. Of course, other MPEG compression standards may be used, as well as any other video compression standard, e.g., JPEG, H.261, and the like. Four independent audio/video sources are used in the exemplary embodiment as shown, but the reader will appreciate that a larger or smaller number of video sources may be used in alternative embodiments under the present invention. Alternative or in addition to the audio/video information, radiologic, biologic or chemical sensor data may be provided to an additional data compression sub-module, and the compressed version of the sensor data multiplexed onto the output transport stream 219. Alternatively, if the sensor data rate is sufficiently low, the sensor data stream may not require compression, and in such an instance, the sensor data could be input directly into the multiplexer 810, and subsequently multiplexed onto the output transport stream with the other compressed sub-streams. Further alternatively, two or more of the sensor data streams could be input to a single data compression sub-module to provide the data compression needed.

The data compression module 800 further includes a data multiplexer 810 having multiple inputs for receiving the respective transport sub-streams 802a-d from sub-modules 802a-802d and an output for providing the multiplexed compressed output transport stream 219. The aggregate bandwidth of the stream 219 may be divided by the number of sources in a variety of ways. Bandwidth may be allocated with symmetrical weighting between all sources, or asymmetrically between the video sources to satisfy a particular requirement. For example, high bandwidth may be allocated to a front facing video source to facilitate navigating the robotic transporter through the tactical environment while side and rear view cameras are allocated low bandwidth to provide better situational awareness to the operator. When the vehicle has reached its destination, it may be desirable to apply the bandwidth allocation equally to all video sources to provide a symmetrical 360 degree view of the tactical environment. The configuration of the bandwidth allocation feature may be remotely controlled through the wireless control link established via a receiver, an embodiment of which is further described below.

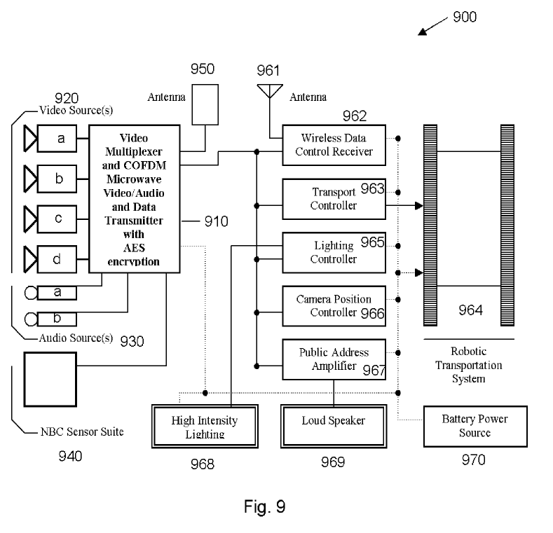

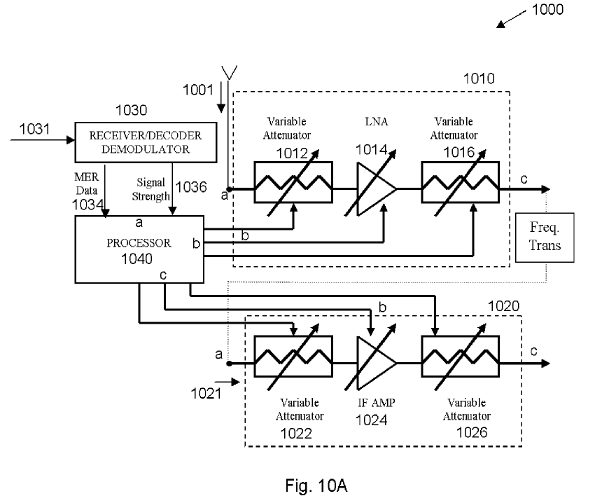

FIG. 9 illustrates a functional block diagram of a robotically-transported communication system in accordance with one embodiment of the present invention. The system 900 is self-contained including wireless command and control functions and on-board primary power for the robot as well as the communications, lighting, and sensor payloads.

The system 900 includes a secure transmitter 910, video sources 920a-d (which may be visual, thermal, etc), audio sensors 930a-b (which may be directional), a sensor suite 940, which may include radiologic, biologic and chemical detectors, and a transmitting antenna 950. In the exemplary embodiment shown, two audio channels are compressed using a linear coding technique. Phase coherency between the two channels is maintained so that the user can listen to the remote audio and localize sounds with respect to the orientation of the vehicle. This feature of the invention is useful in its ability to allow users to locate trapped personnel by auditory queues.

The system 900 further includes a receiving antenna 961 and control receiver 962 (an embodiment of which is further described below) operable to receive and process control signals for the system 900. The system includes a transport controller 963 for controlling the speed, direction, and orientation of the vehicle 964, a light controller 965 for controlling the state of on-board vehicle lights 968, a camera position controller 966 for selecting the mode (e.g., visible, IR, etc.) direction, focus, zoom and other features of the video sources 920a, and a public address amplifier 967 operable to amplify remotely-provided audio signals supplied from the receiver 962 for broadcast from an on-board loudspeaker 969. The system 900 includes one or more portable power sources 970 for providing power to system components. Alternative system embodiments include implementation of a single transmit/receive antenna to allow for smaller size, lower weight and smaller required footprint. Further alternatively, multiple transmit antennae and/or receive antennae are used to provide wider communication bandwidth, and/or fail safe redundancy if one antenna is damaged or is otherwise unable to communicate with a corresponding station. Further alternatively, the system 900 may further include an additional secure transmitter 910, control receiver 962, or the other mission critical components needed to provide fail safe redundancy.

Components of the system 900 may be environmentally sealed or hardened for protection from the harsh conditions typically found during field operations. Mission critical components, such as the secure transmitter, can be housed in a rugged environmental housing milled from 6061-T6 aluminum and/or be radiation hardened.

In an exemplary embodiment, transmitter controls are included on the front panel of the transmitter housing and are operated (subsequent to providing a predefined access code or other encrypted access signal) by selecting options from a software controlled menu as indicated on an LCD screen, the user control screen allowing the operator to select the channel of operation, radio frequency power output level, audio gain, and user encryption key settings. Once deployed, control of the transmission system and camera orientation/configuration may be provided wirelessly over the communication channel. Signals for monitoring and controlling the robotic transportation platform (e.g., status, speed, direction, etc.) may also be multiplexed onto the transport stream 219, or communicated via another channel in an alternative embodiment. Still further, the secure transmitter may be configured to accept input commands only wirelessly, once a predefined access code or similar encryption signal is recognized.

Receiver Architecture

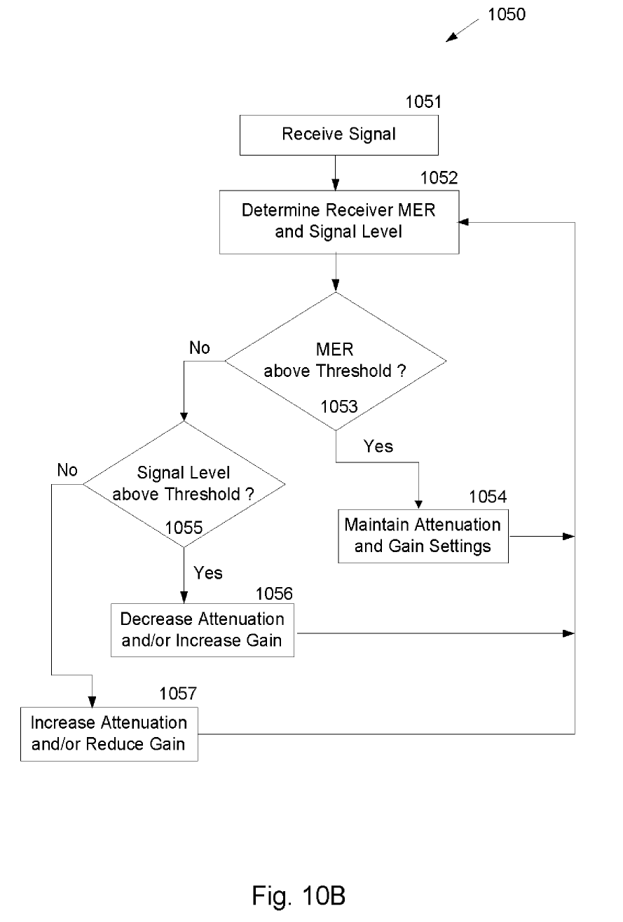

FIG. 10A illustrates an exemplary circuit block diagram 1000 of a receiver 150 or 962 in accordance with one embodiment of the present invention. Similar to the secure transmitter, the receiver circuitry 1000 is advantageously configured to operate in a heavily multi-path environment, and may be employed in tandem with the secure transmitter (for example, implemented in the control receiver 962 in the above described robotically-transported embodiment) in order to provide a receiving capability thereto. Alternatively, the receiver circuitry 1000 and corresponding method of operation may be employed separately from the transmitter, e.g., as a stand-alone base station or portable application (e.g., 150 in FIG. 1) which is operable to receive the transmission from the secure transmitter in a heavily multi-path environment. The receiving circuitry and corresponding method additionally have further applicability to other applications as well, for instance IEEE 802.11x protocol systems.

As shown, the exemplary receiver circuitry 1000 includes a low noise amplifier (LNA) assembly 1010, an intermediate frequency (IF) amplifier assembly 1020, a demodulator/decoder 1030, and a processor 1040. The LNA assembly 1010 includes an input 1010a for receiving a received signal 1001, one or more LNA assembly control inputs 1010b for receiving respective one or more control signals from the processor 1040, and an output 1010c for providing the resulting signal. In a particular embodiment, the LNA assembly 1010 includes an input variable attenuator 1012, an LNA 1014 which may include a feature for providing variable gain, and an output variable attenuator 1016, each of the components 1012, 1014, and 1016 having an input port, a control port and an output port. As shown, the control port is coupled to the processor 1040 for receiving control settings therefrom, as further described below.

The IF amplifier assembly 1020 includes an input 1020a for receiving a signal 1021 which corresponds to the received signal 1001, one or more IF assembly control inputs 1020b for receiving respective one or more control signals from the processor 1040, and an output 1020c for providing the resulting signal. In the particular embodiment shown, the IF amplifier assembly 1020 includes an input variable attenuator 1022, an IF amplifier 1024 which may include a feature for providing variable gain, and an output variable attenuator 1026, each of the components 1022, 1024, and 1026 having an input port, a control port and an output port. As shown, the control port is coupled to the processor at 1040c for receiving control settings therefrom as further described below. A mixer or another type of frequency conversion component is usually coupled between the LNA assembly output port 1010c and the IF amplifier assembly input port 1020a, thereby providing signal 1021 which is a frequency translated version of the received signal 1001. While the LNA 1014 and the IF amplifier 1024 are shown as variable gain type amplifiers, one or both may alternatively be fixed gain devices, in which case their coupling to the processor 1040 is omitted, and the corresponding input and output attenuators provide all of the signal level adjustment. One or more of the components may be discretely fabricated and assembled, or alternatively, all monolithically fabricated on an integrated circuit.

The receiver 1000 further includes a demodulator/decoder 1030 having an input coupled to receive a demod input signal 1031, a first output for providing a detected modulation error ratio (MER) signal 1034, and a second output for providing a detected signal level 1036. The demodulator/decoder 1030 receives the input signal 1031, and based thereon, generates a MER signal 1034 and a signal strength signal 1036. The demod input signal 1031 is representative of the received signal, and in one embodiment consists of the signal output from 1020c of the IF amplifier assembly 1020. Alternatively, the demod input signal 1031 comprises a portion of the received signal 1001 (supplied, e.g., by a 20 dB coupler, not shown). The MER signal 1034 indicates the presently detected modulation error ratio of the receiver 1000, and the signal strength signal 1036 indicates the magnitude of the received signal 1001. The demodulator/decoder 1030 in a particular embodiment comprises the receiver's main demodulator/decoder operable to demodulate/decode the received signal into a data stream of audio/video/sensor information for subsequent processing by conventional receiver backend circuitry (not shown).

Processor 1040 includes inputs 1040a for receiving the MER signal 1034 and the signal strength signal 1036, one or more LNA control outputs 1040b for providing control signals to components of the LNA assembly 1010, and one or more IF control outputs 1040c for providing control signals to the IF amplifier assembly 1020. While not shown, the processor 1040 may additionally include an input for programming or loading the processor 1040 with gain/attenuation adjustment sequences and/or predetermined values of the MER and signal strength signals, embodiments which are used as further described below.

FIG. 10B illustrates the corresponding operation 1050 of the receiver shown in FIG. 10A, which, at 1051 includes the operation of receiving a signal within the expected frequency range of a signal broadcast from a secure transmitter. This process is typically determined through the use of front end amplification, filtering and frequency translation (up and/or down conversion), which in one embodiment is performed using the antenna, LNA assembly, frequency converter and IF amplifier assembly shown in FIG. 10A. Next at 1052, the receiver MER and received signal level is determined. In a particular embodiment, the demodulator/decoder 1030 determines these parameters based upon the demod input signal 1031 received. The demod input signal 1031 is representative of the received signal, and in one embodiment consists of the signal output from 1020c of the IF amplifier assembly 1020. Alternatively, the demod input signal 1031 comprises a portion of the received signal 1001 (supplied, e.g., by a 20 dB coupler, not shown).

As known in the art, MER is a figure of merit for a vector modulator radio frequency system which indicates how far from ideal the data points of the demodulated IQ constellation are located. Low MER is often times indicated when high energy early echoes are received with the desired carriers. Additionally, because the high energy early echoes occur at the same frequency as the desired carriers, the amplitude of the high energy early echoes can degrade the receiver's linearity by overloading the LNA 1014 and IF amplifier 1024, and producing non-linear signal artifacts (intermodulation distortion). The magnitude/level of received signal 1001 represents an integrated sum of the power received at the antenna over the bandwidth of interest, which includes both the desired signal and the high energy early echo signals.

The demodulator/decoder 1030 in a particular embodiment is further operable to generate a modulation error rate signal 1032 indicating the receiver MER, and a signal strength signal 1036 indicating the magnitude of received signal 1001. These signals 1032 and 1036 are supplied to the processor 1040 which is operable to perform the operation of 1053, in which a determination is made as to whether the receiver MER is above a predefined receiver MER threshold. The predefined receiver MER threshold will vary depending upon the particulars of the communication system, environment, desired data rate, power level, and a host of other factors. Generally, a minimum threshold for receiver MER would be in the range of 10 dB to 35 dB, and more particularly in the range of 15 dB to 25 dB.

If the receiver MER is determined as being at or above its predefined thresholds the current attenuation and gain settings for the variable attenuators 1012, 1016, 1022 and 1026, and the LNA and IF amplifier 1014 and 1024, respectively are maintained at 1054. The process then returns to 1052 after a period of time, for example, 1 ms, to continue updating the state of the attenuators and amplifiers for the most optimal operating condition.

If the receiver MER is determined as being below its respective thresholds at 1053, the process continues at operation 1055 in which a determination is made as to whether the received signal level (as indicated by the signal strength signal 1036) is high/above its corresponding threshold. If so, this is an indication that the high energy early echoes are overloading the receiver. In such an instance, the processor 1040 controls one or both of the LNA assembly attenuators 1012 and 1016, and/or one or both of the IF amplifier assembly attenuators 1022 and 1026 to increase their attenuation level, so as to reduce the level of the signal being supplied to and output from the LNA and IF amplifiers 1014 and 1024. In this manner, the level of the input signal is reduced, thereby improving the linearity of the system. Alternatively or in addition, the processor 1040 may operate to decrease the gain of one or both of the LNA 1014 and the IF amplifier 1024. Exemplary embodiments as to the predefined threshold for the received signal level will generally be in the range from −95 to −20 dBm (50 Ω, 8 MHz), and more particularly in the range from −50 to −40 dBm (50 Ω, 8 MHz).

Preprogrammed sequences by which the attenuation and/or gain setting in one or more of the components 1010 and 1020 will be apparent to those skilled in the art. For example, the processor 1040 may be preprogrammed to decrease the gain in amplifiers 1014 and 1024 and/or increase the attenuation settings in attenuators 1012, 1016, 1022 and 1026 such that the gain of the LNA and IF amplifiers moves toward each respective amplifier's mid-range gain settings, and the attenuation level of attenuators 1012, 1016, 1022 and 1026 move toward their mid-range attenuation settings. Such a sequence provides maximum tuning range flexibility for a subsequent operation. Other sequences are of course possible as well. For example, in an application in which the secure transmitter and receiver are located relatively close to one another and in an extreme multi-path environment, a setting which optimizes receiver linearity may be preferred. In such an embodiment, high attenuation settings for the forward-most (closest to the receiving antenna) attenuators and lowest gain for the LNA may be preferred. The process subsequently returns to 1053 after a period of time to continue monitoring and adjusting the state of the attenuators and amplifiers to their most optimal level.

If the determination at 1055 is negative, the detected signal level is low and may possibly be increased with improvement to, or no further degradation of the MER. Accordingly in 1057, the processor 1040 operates to increase the gain of the LNA 1014 and/or the IF amplifier 1024, and/or decrease the attenuation of attenuators 1012, 1016, 1022 and/or 1026. In a particular embodiment, the processor 1040 increases the gain in amplifiers 1014 and 1024 and/or decreases the attenuation settings in attenuators 1012, 1016, 1022 and 1026 such that the gain of the LNA and IF amplifiers move toward their respective mid-range gain settings, and the attenuation level of attenuators 1012 and 1022 move toward their mid-range attenuation settings, thereby allowing maximum tuning range flexibility for a subsequent operation.

In another embodiment, for example when the secure transmitter and receiver are located relatively far away and/or the multi-path environment is not extreme, a setting which minimizes receiver noise contribution may be preferred. In such an embodiment, the forward most attenuators are reduced to their lowest settings, and the gain setting of the LNA is set to its highest setting practical.

As readily appreciated by those skilled in the art, any of the described processes/operations may be implemented in hardware, software, firmware or a combination of these implementations as appropriate. In addition, some or all of the described processes/operations may be implemented as computer readable instruction code resident on a computer readable medium (removable disk, volatile or non-volatile memory, embedded processors, etc.), the instruction code operable to control a computer or other such programmable device to carry out the intended functions.

The foregoing description has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A secure transmitter, comprising:
a data compression module, comprising:
a plurality of data compression sub-modules, at least one of the data compression sub-modules having an input configured to receive video data, the at least one data compression sub-module configured to receive video data operable to compress the received video data to a predefined bandwidth, wherein the at least one data compression sub-module configured to receive video data outputs a transport sub-stream comprising the bandwidth-compressed video data; and
a multiplexer having a respective plurality of inputs and an output, each input coupled to receive one of the plurality of transport sub-streams, the multiplexer operable to multiplex each of the transport sub-streams into an output transport stream;
an encryption module having an input coupled to receive the transport stream and configured to apply an encryption algorithm thereto, the encryption module outputting, in response, an encrypted transport stream; and
a coded orthogonal frequency division multiplex module coupled to receive the encrypted transport stream and to produce, in response, an output signal comprising a plurality of sub-carriers, each sub-carrier modulated by data in the encrypted data stream.

2. The secure transmitter of claim 1, wherein at least one of the plurality of data compression sub-modules is configured to receive sensor data selected from the group consisting of radiologic sensor data, biologic sensor data, or chemical sensor data.

3. The secure transmitter of claim 1, wherein the at least one data compression sub-module configured to receive video data is operable to compress the received data into a format selected from the group consisting of MPEG, JPEG, and H.261.

4. The secure transmitter of claim 1, wherein the received data further comprises encryption data, and wherein the encryption module is configured to apply, using the received encryption data, an advanced encryption standard to the received transport stream to produce the encrypted transport stream.

5. The secure transmitter of claim 1, wherein the coded orthogonal frequency division multiplex module comprises:
a data encoder coupled to receive the encrypted transport stream, the FEC encoder operable to (i) apply forward error correction to the encrypted transport stream to generate a stream of FEC-encoded symbols, (ii) generate an interleaved arranged of symbols received from the FEC encoder, and (iii) insert a predefined cyclic prefix into each symbol of the interleaved symbol stream, thereby producing an encoded transport stream;
a multi-carrier processor coupled to receive the encoded transport stream, the multi-carrier processor configured to modulate the encoded transport stream onto a plurality of substantially orthogonal sub-carrier signals to produce a respective plurality of modulated sub-carriers, the respective plurality of modulated sub-carriers defining a composite signal; and
a waveform generator coupled to receive and convert the composite signal into an output signal.

6. The secure transmitter of claim 5, wherein the multi-carrier processor applies an inverse fast fourier transform to generate the plurality of substantially orthogonal sub-carriers.

7. The secure transmitter of claim 5, wherein the encoded transport stream is modulated onto a plurality of the substantially orthogonal sub-carriers using phase shift key modulation.

8. The secure transmitter of claim 5, wherein the phase shift key modulation comprises quadrature phase shift key modulation.

9. The secure transmitter of claim 5, wherein the encoded transport stream is modulated onto a plurality of substantially orthogonal sub-carriers using amplitude modulation.

10. The secure transmitter of claim 9, wherein the amplitude modulation comprises QAM-16.

11. The secure transmitter of claim 1, further comprising a robotic transportation platform operable to transport the secure transmitter using remote control signals.

12. A receiver, comprising:
a low noise amplifier (LNA) assembly having an input coupled to receive a received signal, an output, and one or more LNA assembly control inputs, the LNA assembly having a variable gain or a variable attenuation responsive to a control signal supplied to the one or more LNA assembly control inputs;
an intermediate frequency (IF) amplifier assembly having an input coupled to the output of the low noise amplifier assembly, an output, and one or more IF assembly control inputs, the IF amplifier assembly having a variable gain or a variable attenuation responsive to a control signal supplied to the one or more IF assembly control inputs;
a demodulator having an input for receiving a signal representative of the received signal, the demodulator operable to provide a modulation error ratio (MER) signal and a signal strength signal, wherein the MER signal indicates the MER of the receiver and the signal strength signal indicates the signal level of the received signal; and
a processor having an input coupled to receive the MER signal and the signal strength signal, one or more LNA control outputs coupled to respective one or more LNA assembly control inputs, and one or more IF control outputs coupled to respective one or more IF assembly control inputs, the processor further comprising:
means for determining whether the receiver MER as indicated by the MER signal is above a predefined MER threshold; and
means for determining whether the received signal level is above the predefined signal level threshold;
wherein, when the receiver MER is determined as being below the predefined MER threshold and the received signal level is determined as being above the predefined signal level threshold, the processor is operable to (i) increase the attenuation of the LNA assembly, or (ii) increase the attenuation of the IF amplifier assembly, or (iii) decrease the gain of the LNA assembly, or (iv) decrease the gain of the IF amplifier assembly.

13. The receiver of claim 12, wherein, when the receiver MER is determined as being below the predefined MER threshold and the received signal level is determined to be below the predefined signal level threshold, the processor is further operable to (i) decrease the attenuation of the LNA assembly, or (ii) decrease the attenuation of the IF amplifier assembly, or (iii) increase the gain of the LNA assembly, or (iv) increase the gain of the IF amplifier assembly.

14. The receiver of claim 12, wherein the LNA assembly comprises:
an input variable attenuator having an input coupled to receive the received signal, a control input coupled to the processor, and an output;
a variable gain LNA having an input coupled to the output of the input variable attenuator, a control input coupled to the processor, and an output; and
an output variable attenuator having an input coupled to the output of the variable gain low noise amplifier, a control input, and an output;
wherein, the processor, responsive to comparing the MER and the signal level to corresponding predetermined thresholds values for each, controls the attenuation level of the input and output attenuators, and the gain setting of the variable gain LNA.

15. The receiver of claim 12, wherein the IF amplifier assembly comprises:
an input variable attenuator having an input coupled to receive a signal corresponding to the input signal, a control input coupled to the processor, and an output;
a variable gain IF amplifier having an input coupled to the output of the input variable attenuator, a control input coupled to the processor, and an output; and
an output variable attenuator having an input coupled to the output of the variable gain low noise amplifier, a control input, and an output;
wherein, the processor, responsive to comparing the detected MER and signal level to corresponding predetermined thresholds values for each, controls the attenuation level of the input and output attenuators, and the gain setting of the variable gain IF amplifier.

16. A secure communication system, comprising:
a secure transmitter, which includes:
a data compression module, comprising:
a plurality of data compression sub-modules, at least one of the data compression sub-modules having an input configured to receive video data, the at least one data compression sub-module configured to receive video data operable to compress the received video data to a predefined bandwidth, wherein the at least one data compression sub-module configured to receive video data outputs a transport sub-stream comprising the bandwidth-compressed video data; and
a multiplexer having a respective plurality of inputs and an output, each input coupled to receive one of the plurality of transport sub-streams, the multiplexer operable to multiplex each of the transport sub-streams into an output transport stream;
an encryption module having an input coupled to receive the transport stream and configured to apply an encryption algorithm thereto, the encryption module outputting, in response, an encrypted transport stream; and
a coded orthogonal frequency division multiplex module coupled to receive the encrypted transport stream and to produce, in response, an output signal comprising a plurality of sub-carriers, each sub-carrier modulated by data in the encrypted data stream; and
a receiver, comprising:
a low noise amplifier (LNA) assembly having an input coupled to receive a received signal, an output, and one or more LNA assembly control inputs, the LNA assembly having a variable gain or a variable attenuation responsive to a control signal supplied to the one or more LNA assembly control inputs;
an intermediate frequency (IF) amplifier assembly having an input coupled to the output of the LNA assembly, an output, and one or more IF assembly control inputs, the IF amplifier assembly having a variable gain or a variable attenuation responsive to a control signal supplied to the one or more IF assembly control inputs; and
a demodulator having an input for receiving a signal representative of the received signal, the demodulator operable to provide a modulation error ratio (MER) signal and a signal strength signal; and
a processor having an input coupled to receive the MER signal and the signal strength signal, one or more LNA control outputs coupled to respective one or more LNA assembly control inputs, and one or more IF control outputs coupled to respective one or more IF assembly control inputs, the processor further comprising:
means for determining whether the receiver MER as indicated by the MER signal is above a predefined MER threshold; and
means for determining whether the received signal level is above the predefined signal level threshold;
wherein, when the receiver MER is determined as being below the predefined MER threshold and the received signal level is determined as being above the predefined signal level threshold, the processor is operable to (i) increase the attenuation of the LNA assembly, or (ii) increase the attenuation of the IF amplifier assembly, or (iii) decrease the gain of the LNA assembly, or (iv) decrease the gain of the IF amplifier assembly.

17. The secure communication system of claim 16, wherein at least one of the plurality of data compression sub-modules is configured to receive sensor data selected from the group consisting of radiologic sensor data, biologic sensor data, or chemical sensor data.

18. The secure communication system of claim 16, wherein the at least one data compression sub-module configured to receive video data is operable to compress the received data into a format selected from the group consisting of MPEG, JPEG, and H.261.

19. The secure communication system of claim 16, wherein, when the receiver MER is determined to be below the predefined MER threshold and the received signal level is determined as being below the predefined signal level threshold, the processor is further operable to (i) decrease the attenuation of the LNA assembly, or (ii) decrease the attenuation of the IF amplifier assembly, or (iii) increase the gain of the LNA assembly, or (iv) increase the gain of the IF amplifier assembly.

20. The secure communication system of claim 16, wherein the secure transmitter is housed on a robotically-transported platform.
